(19) United States
(12) Patent Application Publication
(10) Pub. No.: US 2018/0018115 A1
(43) Pub. Date: Jan. 18, 2018

(54) STORAGE APPARATUS, CONTROL APPARATUS, AND COMPUTER-READABLE STORAGE MEDIUM HAVING STORED THEREIN CONTROL PROGRAM

(71) Applicant: FUJITSU LIMITED, Kawasaki-shi (JP)

(72) Inventor: Masaki Ikegame, Yokohama (JP)

(73) Assignee: FUJITSU LIMITED, Kawasaki-shi (JP)

(21) Appl. No.: 15/611,852

(22) Filed: Jun. 2, 2017

(30) Foreign Application Priority Data
Jul. 15, 2016 (JP) 2016-139928

(51) Int. Cl. G06F 3/06

(52) U.S. Cl. CPC G06F 3/0619; G06F 3/0686; G06F 3/0647; G06F 3/065

(57) ABSTRACT

A storage apparatus includes a library apparatus comprising a plurality of removable media contained therein, and a control apparatus configured to control accesses to the plurality of removable media on a file-by-file basis. The control apparatus may include a memory, and a processor connected to the memory. The processor may be configured to cause the library apparatus to execute a migration process of data between removable media on a file-by-file basis; in response to an access request being received while the migration process is being executed, determine whether or not the access request targets an executing removable medium in which the migration process is being executed; when the access request targets the executing removable medium, control to suspend the migration process; and after the migration process is suspended, access an access-target file recorded in the removable medium targeted by the access request.

### CROSS-REFERENCE TO RELATED APPLICATION

This application is based upon and claims the benefit of priority of the prior Japanese Patent Application No. 2016-139928, filed on Jul. 15, 2016, the entire contents of which are incorporated herein by reference.

### FIELD

The present disclosure relates to a storage apparatus, a control apparatus, and a computer-readable storage medium having stored therein a control program.

### BACKGROUND

A storage apparatus is known which has a library containing multiple removable media, e.g., magnetic tape cartridges and optical disk cartridges.

In such a library, data transfers (e.g., migrations) may be carried out between removable media. Upon a migration operation, an operator stops the operation of the library, inserts or connects migration-source and migration-destination removable media to respective reader devices (e.g., drives), and uses a backup application to transfer data on a medium-by-medium basis.

The reason why data is moved on a removable medium by removable medium basis is that removable media (e.g., tapes) are often used for a backup of data in which accesses occur at particular timing, and data is compressed in the backup and hence accesses on a file-by-file basis become impossible.

In the meantime, file systems are known which enable files to be handled individually and permit accesses to files on removable media, and one of such file systems is a Linear Tape File System (LTFS). The LTFS enables operations of library as a data archive, as well as a backup.

Patent Document 1: Japanese Laid-open Patent Publication No. 2001-75843

Patent Document 2: Japanese Laid-open Patent Publication No. 2005-228170

Patent Document 3: Japanese Laid-open Patent Publication No. 2009-245004

In the LTFS, however, migration operations are not taken into consideration. Accordingly, when access information (e.g., a file path) of the location of data to be accessed is modified triggered by a file movement between removable media, it is difficult for a user to keep track of the modification of the location.

As described above, in a storage apparatus employing the LTFS, an update of access information of a file after a migration may cause an archive operation to be stopped.

### SUMMARY

According to an aspect of the embodiments, a storage apparatus discussed therein may include a library apparatus comprising a plurality of removable media contained therein, and a control apparatus configured to control accesses to the plurality of removable media on a file-by-file basis. The control apparatus may include a memory, and a processor connected to the memory. The processor may be configured to cause the library apparatus to execute a migration process of data between removable media on a file-by-file basis; in response to an access request being received while the migration process is being executed, determine whether or not the access request targets an executing removable medium in which the migration process is being executed; when the access request targets the executing removable medium, control to suspend the migration process; and after the migration process is suspended, access an access-target file recorded in the removable medium targeted by the access request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an exemplary configuration of a storage system in accordance with one embodiment;

FIG. 2 is a block diagram depicting an exemplary configuration of a library;

FIG. 3 is a block diagram depicting an exemplary functional configuration of an LTFS server;

FIG. 4 is a diagram illustrating one example of link management information;

FIG. 5 is a diagram illustrating one example of how user operations change when no symbolic link is used;

FIG. 6 is a diagram illustrating one example of how user operations change when symbolic links are used;

FIG. 7 is a flowchart illustrating exemplary operations of a data transfer process;

FIG. 8 is a flowchart illustrating exemplary operations of an access receiving process;

FIG. 9 is a flowchart illustrating exemplary operations of a file access process A;

FIG. 10 is a flowchart illustrating exemplary operations of a file access process B; and

FIG. 11 is a block diagram depicting an exemplary hardware configuration of a computer.

### DESCRIPTION OF EMBODIMENTS

Hereinafter, an embodiment of the present disclosure will be described with reference to the drawings. An embodiment described below is, however, merely exemplary, and it is not intended to exclude a wide variety of modifications to and applications of the technique which are not explicitly described below. For example, the present embodiment may be practiced in a wide variety of modifications without departing from the spirit thereof.

Note that in the drawings referenced to in the descriptions below, elements denoted by like reference symbols may denote the same or similar elements, unless otherwise stated.

### (1) One Embodiment

The LTFS controls to permit a removable medium to be mounted to a server, and files on that removable medium to be accessed individually, in the similar manner as other storage devices, such as magnetic disk devices, e.g., hard disk drives (HDDs), and semiconductor drive devices, e.g., a solid state drives (SSDs).

As a result, accessibility to the files is improved, as compared to operations in a backup to a removable medium, and operations as an archive are achieved, as well as the backup.

Because backup software controls an accesses to removable media in operations of a backup to a removable medium, a user does not sometimes know the backup-destination removable medium. In an archive operation, in contrast, the user can keep track of a removable medium and make accesses thereto.

As set forth above, because a conventional migration technique, however, does not support archive operations in the LTFS, the following disadvantages may be experienced in continuing the operation during an execution of a migration.

While magnetic tape cartridges, such as linear tape open (LTO) cartridges, will be described as example of removable media, the following descriptions are similarly applied to magneto-optical tape cartridges, optical disks, and optical disk cartridges. Examples of optical disks and optical disk cartridges include, compact discs (CD), digital versatile discs (DVD), Blu-ray® Discs, holographic versatile discs (HVDs), and the like. Removable media are also be referred to as “storage media”, “exchange media”, “external storage devices”, “removable media”, or the like. Hereinafter, magnetic tape cartridges may also be simply referred to as “tapes”.

(a) In an LTFS operation, a user accesses a file by specifying the file path of that file in the manner similar to handle files on any other type of storage devices. In this case, the file path is determined by where a tape is mounted on a server and the label of the tape storing the file, for example. When the user operates the LTFS via some sort of upper-level software, instead of directly operating the LTFS, the file path is also to be specified for the upper-level software.

Accordingly, after a migration is carried out, the user has to keep track of which file has been moved to which medium, and has to reset file paths in a case in which an upper-level software is used.

For example, a situation is considered wherein a tape is mounted to “/mnt/ltfs”, and a file “file1” is migrated from a medium having a label of “LTO001L6” to a medium having a label of

“LTO100L7”. In this case, a user modifies a file path “/mnt/ltfs/LTO0001L6/file1” to “/mnt/ltfs/LTO100L7/file1”.

In this manner, once a migration is carried out, a user has to keep track of migration-destinations of files, and modify the file paths of all of the media and files.

(b) When a user accesses a file and updates that file during an execution of a migration, in some cases, the update is not reflected after the migration is completed. This phenomenon occurs because a copy-source file stored in a migration-source medium is updated after a copy of an access-target file to a migration-destination medium has been completed, for example. In this case, the update will not be reflected after the migration unless the updated file is copied to the migration destination.

(c) When a file is tried to be accessed during an execution of a migration, the access may not be made due to conflict of processes or an access may fail under some conditions. This phenomenon occurs when a medium having the file accessed by the user recorded thereon is being used in the migration, or when there is no empty drive available for the file access, for example.

As described above, it may be difficult to smoothly execute a migration of data between tapes while continuing an archive operation of tapes using the LTFS.

Accordingly, in one embodiment, a system will be described which enables execution of migrations while continuing an operation, and improves the availability of a storage apparatus.

### (1-1) Exemplary Configuration of Storage System

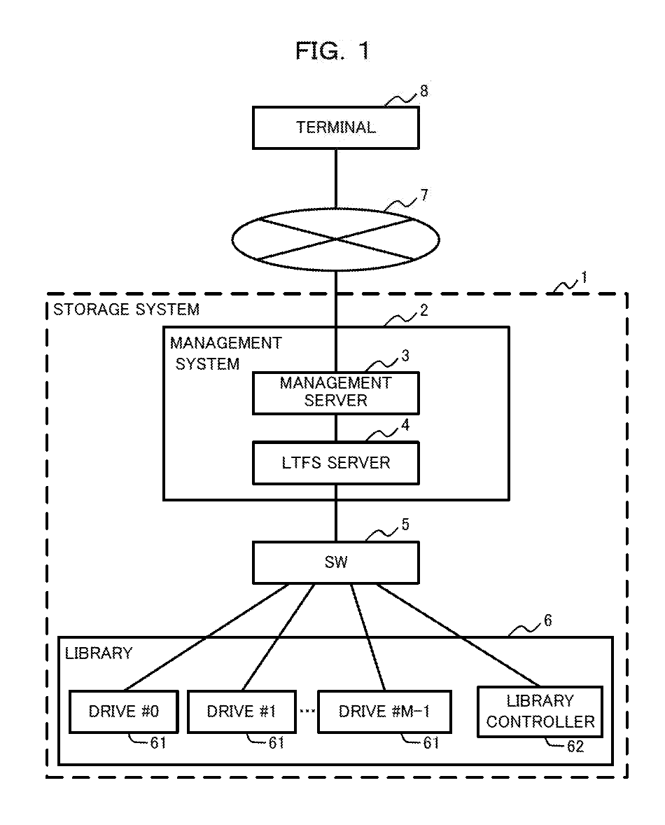

As depicted in FIG. 1, a storage system 1 in accordance with one embodiment may include a management system 2, a switch (SW) 5, and a library 6, for example. The storage system 1 represents one example of a storage apparatus. Note that a plurality of at least one of the management system 2, the SW 5, and the library 6 may be present in the storage system 1. Furthermore, the management system 2 and the library 6 may be connected bypassing the SW 5.

In the example in FIG. 1, a terminal 8 may be connected to the management system 2 via a network 7. Note that examples of the network 7 may include an intranet, such as a local area network (LAN) and a wide area network (WAN), and the Internet. The terminal 8 may be a computer, such as a server, a personal computer (PC), a tablet, a personal digital assistant (PDA), a smart phone, or a cellular phone. The terminal 8 may be directly connected to the management system 2 bypassing the network 7.

The management system 2 is a system that manages the storage system 1, and may be embodied by one or more information processing apparatuses. Examples of information processing apparatuses may include computers, e.g., servers and PCs. The management system 2 may include a management server 3 and an LTFS server 4, for example.

Note that the storage system 1 may also include one (or more) LTFS servers 4, instead of the management system 2. In this case, at least a part of functions as the management system 2 and the management server 3 may be integrated into the LTFS server 4.

The terminal 8 and the network 7, the network 7 and the management server 3, and the management server 3 and the LTFS server 4 maybe LAN-connected through LAN cables, for example. Furthermore, the LTFS server 4 and the SW 5, and the SW 5 and the library 6 may be SCSI-connected through FC cables and/or SAS cables, for example. Note that SCSI-connected apparatuses may configure a storage area network (SAN).

The management server 3 carries out a wide variety of managements for the storage system 1. In one embodiment, the management server 3 may instruct the LTFS server 4 to carry out a transfer process (e.g., migration process) of data in response to a request from the terminal 8 or in accordance with a preset schedule, or the like.

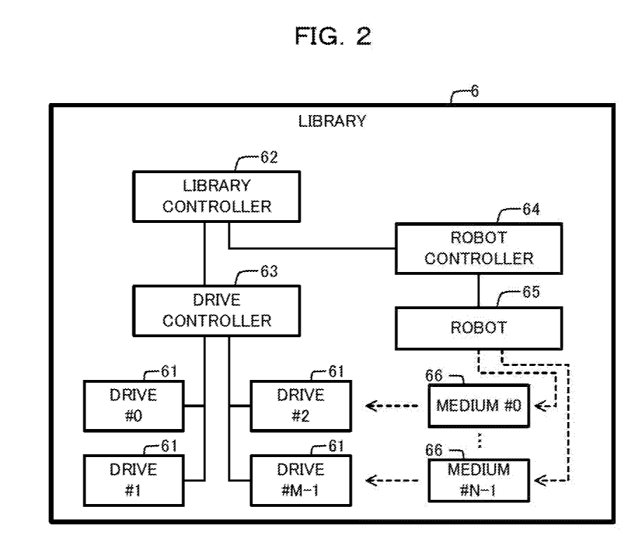

The LTFS server 4 represents one example of a control apparatus that controls accesses to a plurality of media 66 (refer to FIG. 2) on a file-by-file basis. The LTFS server 4 may provide the terminal 8 with the LTFS. Details of the LTFS server 4 will be described later.

The SW 5 is interposed between the management system 2 and the library 6 to adaptively switch connections between the management system 2, and drives 61 and a library controller 62 in the library 6 (each refer to FIG. 1). Examples of the SW 5 include a Fibre Channel (FC) switch and a Serial Attached SCSI (SAS) switch. SCSI is an abbreviation for Small Computer System Interface. Note that the SW 5 may not be directly connected to the library controller 62, but may be connected to the library controller 62 via the drive 61 as surrogates.

The library 6 represents one example of a library apparatus that includes a plurality of removable media contained therein. As depicted in FIG. 2, the library 6 may include the plurality of (M in the example in FIG. 2; M is a natural number) drives 61, the library controller 62, a drive controller 63, a robot controller 64, and a robot 65, for example. Note that a plurality of at least one of the controllers 62-64 and the robot 65 may be present in the library 6. Further, at least one of the controllers 62-64 may not be located in the library 6.

Furthermore, the library 6 may include a plurality of (N in the example in FIG. 2; Nis a natural number) media 66 contained therein. Examples of the media 66 include removable media, such as magnetic tape cartridges, magneto-optical tape cartridges, optical disks, and optical disk cartridges. In the following descriptions, it is assumed that the media 66 are magnetic tape cartridges.

Each drive 61 represents one example of a medium processing apparatus that carries out a wide variety of accesses, such as writes and reads (e.g., records and replays), on a medium 66 inserted or connected to that drive 61. In a migration, one of the plurality of (e.g., two) drives 61 may be used to read data from a migration-source medium 66, and the other may be used to write the data to a migration-destination medium 66.

The library controller 62 controls the entire library 6. For example, the library 6 may control the robot controller 64 and the drive controller 63 in response to an instruction (e.g., command) received from the LTFS server 4, and may send the LTFS server 4 a reply to that command.

The drive controller 63 carries out a wide variety of controls on the drives 61 under the control of the library controller 62.

The robot controller 64 carries out a wide variety of controls on the robot 65 under the control of the library controller 62.

The robot 65 represents one example of a conveyer apparatus that picks up the media 66, delivers the media 66, and connects and inserts the media 66 to the drives 61, for example.

### (1-2) Exemplary Configuration of LTFS Server

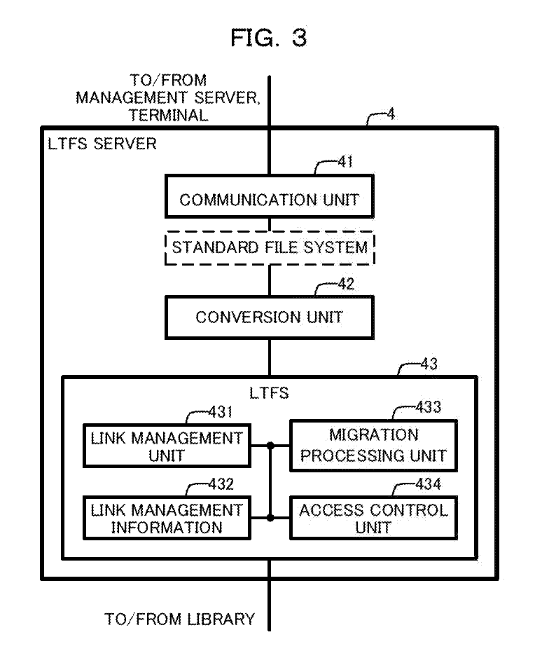

FIG. 3 is a diagram illustrating one example of an exemplary functional configuration of the LTFS server 4. As depicted in FIG. 3, the LTFS server 4 may include a communication unit 41, a conversion unit 42, and an LTFS 43, for example.

The communication unit 41 carries out a wide variety of communications with the terminal 8 or the management server 3, such as receives requests or transmits replies.

The conversion unit 42 represents one example of a software interface that provides a function to create a user-specific file system. Examples of the conversion unit 42 include Filesystem in Userspace (FUSE) that is used in operating systems (OSs) based on Unix®, for example. The functions of the LTFS 43 running on an OS may be provided using the conversion unit 42.

The conversion unit 42 bridges between the LTFS 43 and the kernel. In other words, files of the LTFS 43 are converted such that they can be apparently handled by a user as files on a standard file system. Thereby, the communication unit 41 can receive an access request from the terminal 8 or the management server 3 and can return a reply to that access request, as an access to a file on the standard file system. Examples of standard file systems include a wide variety of standard file systems used in Linux®, such as Ext4, Ext3, Ext2, JFS, ReiserFS, and XFS, for example.

The LTFS 43 provides the terminal 8 or the management server 3 with the functions of the LTFS via the conversion unit 42. The LTFS 43 may include a link management unit 431, a migration process unit 433, and an access control unit 434, for example. In addition, the LTFS 43 may store and manage information of link management information 432 in a storage area (not illustrated), such as a memory.

The link management unit 431 represents one example of a management unit that manages file paths and soft links to media 66 that record files, by relating them to each other. Examples of soft links include symbolic links, aliases, short cuts, and the like. Hereinafter, soft links will be described as symbolic links.

The link management unit 431 may provide a user with a symbolic link of each file, together with the conversion unit 42. Using this information, a user can transmit an access request specifying an access-target file with a symbolic link from the terminal 8.

Furthermore, the link management unit 431 may update, for each file, a copy of which has been completed in a migration process, the file path associated with a symbolic link, to the file path of a migration-destination medium 66.

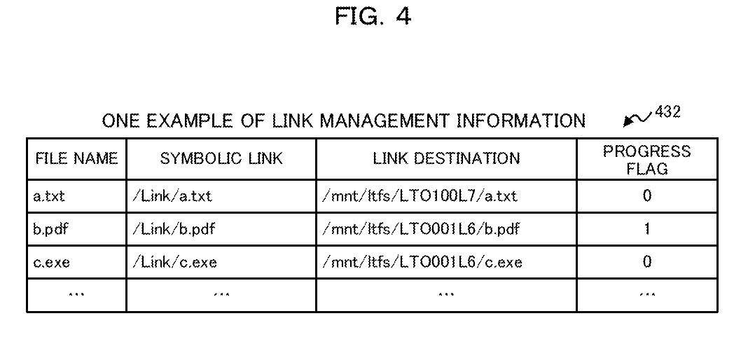

The link management unit 431 may manage symbolic links by looking up and updating the link management information 432. FIG. 4 is a diagram illustrating one example of the link management information 432. While the link management information 432 is illustrated in a tabular format in FIG. 4 for the purpose of convenience, this is not limiting. The information of the link management information 432 may be stored into a memory or the like in a wide variety of forms.

As depicted in FIG. 4, the link management information 432 may include information of the “file name”, the “symbolic link”, the “link destination”, and the “progress flag”, for example. The “file name” represents one example of information identifying a file recorded in a medium 66.

The “symbolic link” represents one example of a soft link to be presented to a user, and is considered as a virtual file path. The example in FIG. 4 illustrates a case in which each file is mounted to “/Link/”. The “link destination” represents one example of the file path associated with a symbolic link, and is considered as a real file path for the virtual file path. The example in FIG. 4 illustrates a case in which each file is mounted to each tape on the layer under “/mnt/ltfs/”. Note that the “link destination” may indicate a migration-source file path of a file to be migrated prior to a migration, and may indicate a migration-destination file path of the file after the migration.

The “progress flag” represents one example of information about the progress of the migration. FIG. 4 depicts an example in which a value of “1” indicating “executing” is set to a file that is undergoing a migration, whereas a value of “0” is set to files that are not targets of a migration, files before an execution, or files that have undergone the migration. The “progress flag” will be described later.

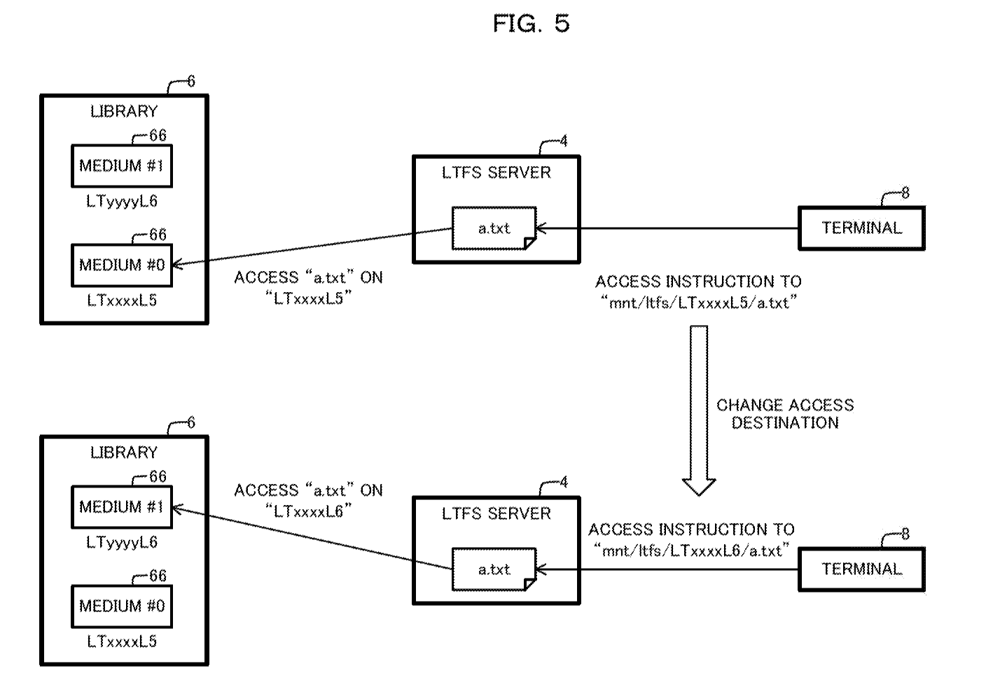

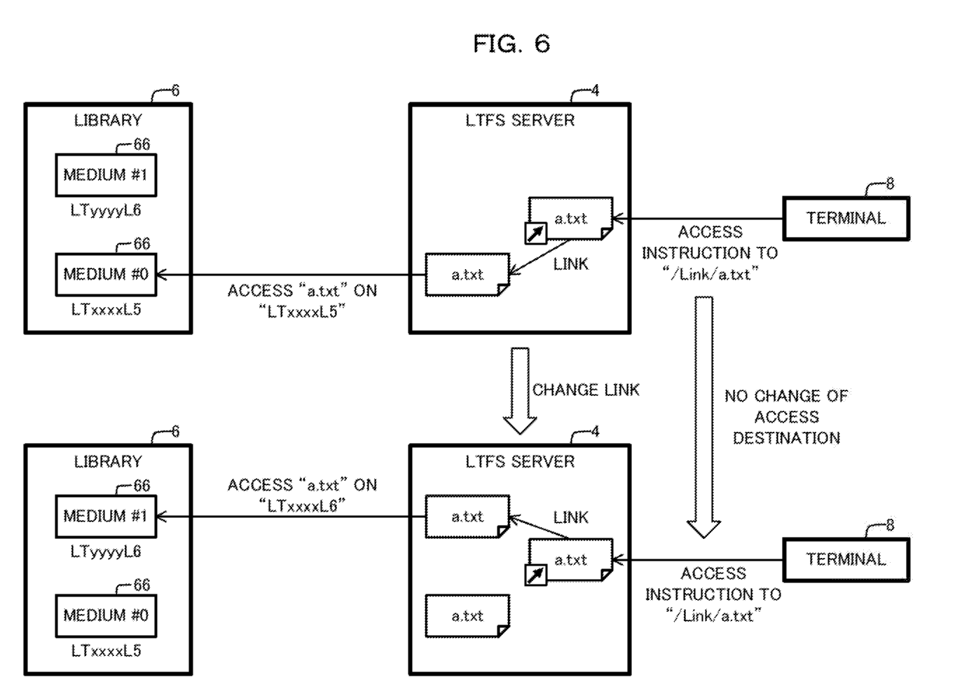

FIGS. 5 and 6 are diagrams illustrating how user operations change when a migration is executed from a tape “LTxxxxL5” to a tape “LTyyyyL6”, in both cases in which no symbolic link is used and symbolic links are used.

As depicted in FIG. 5, when no symbolic link is used, for accessing a file “a.txt”, the terminal 8 makes an access instruction to “mnt/ltfs/LTxxxxL5/a.txt” prior to a migration. The LTFS server 4 accesses “a.txt” on a medium 66 (medium #0) that has been instructed and is labeled as “LTxxxxL5”, and returns a reply to the terminal 8.

On the other hand, for accessing the file “a.txt” after the migration, the terminal 8 resets an access destination (e.g., file path) for the same file once again, and makes an access instruction to “mnt/ltfs/LTyyyyL6/a.txt”. The LTFS server 4 accesses “a.txt” on a medium 66 (medium #1) that has been instructed and is labeled as “LTyyyyL6”, and returns a reply to the terminal 8.

In contrast, as depicted in FIG. 6, when symbolic links are used, for accessing the file “a.txt”, the terminal 8 makes an access instruction to “/Link/a.txt” both prior to and after a migration.

Prior to the migration, the LTFS server 4 obtains a file path “/mnt/ltfs/LTxxxxL5/a.txt” from the link management information 432, accesses “a.txt” on the medium #0, and returns a reply to the terminal 8. In contrast, after the migration, because the file path to “/Link/a.txt” has been updated to “/mnt/ltfs/LTyyyyL6/a.txt”, the LTFS server 4 accesses “a.txt” on the medium #1, and returns a reply to the terminal 8.

As described above, in the LTFS server 4, management of the symbolic links by the link management unit 431 allows all of file accesses to be made using the symbolic links. Because links to migration-destination files are updated after the migration, a user does not have to keep track of actual file locations both prior to and after migrations.

Furthermore, in a case in which upper-level software to the LTFS server 4 is used, once file paths set to the upper-level software are specified to symbolic links, a user does not have to reset them after the migration.

As described above, because accesses through symbolic links allow files to be managed to be changed substantially and a user does not have to keep track of migration-destinations of files and does not have to modify file paths, the convenience can be improved.

The migration process unit 433 represents one example of a processing unit that causes the library 6 to execute a migration process of data between media 66 on a file-by-file basis.

The migration process unit 433 may execute a migration process in response to an instruction from the terminal 8 or the management server 3. At this time, the migration process unit 433 may execute a migration on a file-by-file basis, rather than on a medium 66 by medium 66 basis. In a migration process, every time a copy of a file is completed, symbolic links are updated by the link management unit 431.

Thereby, even when a migration of an access-target medium 66 is being executed, accesses to copied files are made to copy-destination media 66. Further, although an access to a file prior to a copy is to be made to a copy-source medium 66, after that files is updated triggered by an access (e.g., write access), a copy of that file is executed by a migration process.

Therefore, both before and after an access-target file is copied, all of changes are reflected to migration-destination media 66 in a reliable manner after the migration is completed. Accordingly, during a migration, even when a user makes an operation to access a medium 66 that is undergoing the migration, no failure of a file access occurs.

Furthermore, symbolic links are updated during an execution of a migration. Accordingly, a user can work on a file that has been copied to a migration destination without waiting for a completion of the migration operation.

The access control unit 434 represents one example of a determination unit, a control unit, and an access unit. The access control unit 434 may control an access in response to an access request to a file from a user. Upon controlling accesses, the access control unit 434 may confirm at least one of the following (1) to (4), and may control to suspend or resume the migration by the migration process unit 433 in accordance with a confirmation result:

(1) Whether or not a migration is being executed.

(2) Whether or not there is an available free drive 61.

(3) Whether or not an access-target file is the one recorded in a copy-executing medium 66.

(4) The remaining copy time of a file that is being copied.

For example, in response to receiving an access request during an execution of a migration process, the access control unit 434 may determine whether or not the access request is targeted to an executing medium 66 that is undergoing a migration as a determination unit (refer to the above-described (1) and (3)). When an access request is targeted to an executing medium 66, that executing medium 66 has been inserted to the drive 61 (refer to the above-described (2)).

Furthermore, when the access request is targeted to the executing medium 66, the access control unit 434 may execute a control to suspend the migration process as a control unit (refer to the above-described (4)). This control may be carried out based on information about the remaining copy time of a file that is being copied in the migration process.

For example, when the remaining copy time is equal to or greater than a given time (e.g., several seconds to a dozen of seconds), the access control unit 434 may stop (e.g., cancel) the ongoing copy of the file and suspend the migration process. At this time, the access control unit 434 may set a value of “1” to the “progress flag” in the link management information 432, via the link management unit 431, for the file the copy of which has been canceled.

Furthermore, when the remaining copy time is smaller than the given time, the access control unit 434 may suspend the migration process after the ongoing copy of the file is completed. At this time, the access control unit 434 may set a value of “1” to the “progress flag” in the link management information 432, via the link management unit 431, for a copy-target file subsequent to the file a copy of which has been completed.

Note that a fixed value may be set to the “given time” based on the allowable delay time of a reply to a user, or may be set in advance by a developer, an administrator, a user, or the like, of the system, for example.

Furthermore, an estimated value of the “remaining copy time” may be calculated using the following equation. Because the “drive transfer speed” has been set in advance for each of the vendor and/or generation of the drives 61 in the following equation, the LTFS 43 may retain the status of the “drive transfer speed” in advance .

Remaining copy time=(File size—Copied data volume)/Drive transfer speed

As described above, by controlling suspension of a migration based on information about the remaining copy time, it is possible to limit the delay of a reply to a user within an allowable time, for example, and a reply performance can be improved.

The access control unit 434 may access an access-target file recorded in a medium 66 that is a target of an access request after the migration process has been suspended, as an access unit.

Furthermore, the access control unit 434 may execute a control to resume a suspended migration process after an access is executed. In the control to resume, the access control unit 434 may obtain information about a file of which the “progress flag” has been set to a value of “1” from the link management information 432 via the link management unit 431, and may resume the migration process starting from that file.

Note that the access control unit 434 may suspend a migration process based on the remaining copy time when a medium 66 that is a target of an access request is not used in the migration process and there is no available free drive 61.

In this case, the access control unit 434 may control an exchange of media 66 to a drive 61 after the migration process has been suspended. Note that the “given time” in this case may be time taken the time to exchange of media 66, into considerations. Further, in this case, the access control unit 434 may select a medium 66 of which a migration has been suspended, as a medium 66 to be removed from a drive 61.

As described above, in accordance with the access control unit 434, when the time until a completion of a copy in a migration process is expected to be equal to or greater than the given time, that copy is canceled to give a priority to a user access. This prevents occurrence of a wait time for a user access when the size of a file being copied is extremely large and a longer time is required before the copy completes.

Furthermore, when there is no available free drive 61 during an execution of a migration, the migration process is suspended to secure a free drive 61. Thereby, a failure of a file access due to timeout or the like may be prevented.

As described above, in accordance with the storage system 1, management of symbolic links and an adaptive control of accesses during an execution of a migration allow a user to use an archive of the LTFS 43, without being aware of the migration that is being executed. Furthermore, there is no need to suspend an archive service of the LTFS 43 and resetting for upper-level software that is used, and file update during the migration can be reflected to a migration-destination medium 66.

In migrations of tapes, optical disks, and the like, conditions that are not applicable to data migrations of other storage devices (e.g., HDDs) are considered. Examples of such conditions include executions of deliveries and exchanges of media 66, read and write time of data (this is because sequential accesses are carried out for tapes), and the usage statuses and the access orders of the drives 61. Therefore, in simplified transfers of data and updates of links in accordance with the transfers, it is difficult to execute a migration while continuing an operation.

In contrast, in the storage system 1, by adaptively controlling user accesses, considering the above-described conditions for media 66 (e.g., tapes and optical disks), it is possible to achieve a migration while continuing an operation.

In the library 6 having the media 66 (e.g., tapes and optical disks) contained therein, there is a possibility that a new drive 61 or other components does not support the media 66 after a replacement of an old drive 61 or the like with the new drive 61 or the like, for some software or physical reason, for example. To address such a situation, a previous-generation medium 66 may be migrated to a new generation medium 66 supported by a new drive 61. To such a migration operation, processes by the link management unit 431, the migration process unit 433, and the access control unit 434 described above can also be applied.

### (1-3) Exemplary Operations

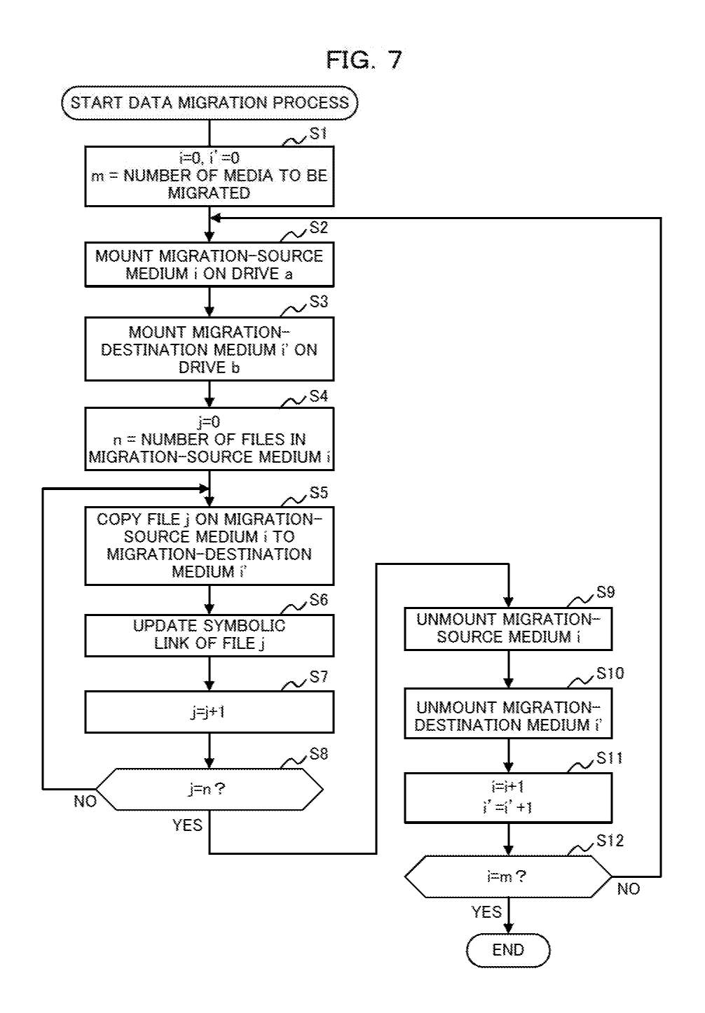

Next, referring to FIGS. 7-10, exemplary operations of the storage system 1 in accordance with one embodiment will be described.

### (1-3-1) Migration Process

Initially, exemplary operations of a migration process by the LTFS server 4 will be described.

Note that the migration process may be executed by the LTFS 43 in the LTFS server 4 in response to a request from the terminal 8 operated by a user or the management server 3, for example. The request for the migration process may include information specifying migration-source and migration-destination media 66.

While an example will be described in which the migration-source medium 66 and the migration-destination medium 66 correspond to each other one by one, the description may be suitably applied to cases in which a plurality of migration-source media 66 may be migrated to a single migration-destination medium 66, or a single migration-source medium 66 may be migrated to a plurality of migration-destination media 66.

As exemplified in FIG. 7, in response to the request for the migration process, the migration process unit 433 in the LTFS 43 sets a value of “0” to a variable i for migration-source media 66 and a variable i′ for migration-destination media 66 to initialize them. The migration process unit 433 also sets the count of migration-source media 66 to be migrated to a variable m based on the request (Step S1).

Subsequently, the migration process unit 433 mounts the migration-source medium 66 (hereinafter, the medium 66 specified by the variable i will be referred to as the “migration-source medium i”) to a drive 61 (hereinafter, referred to as “drive a”) (Step S2). The migration process unit 433 also mounts the migration-destination medium 66 (hereinafter, the medium 66 specified by the variable i′ will be referred to as the “migration-destination medium i′”) to a drive 61 (hereinafter, referred to as “drive b”) (Step S3).

Furthermore, the migration process unit 433 sets a value of “0” to a variable j for files to initialize it, obtains information about the count of files on the migration-source medium i, and sets the obtained count of files to a variable n (Step S4).

The migration process unit 433 then copies a file (hereinafter, the file specified by the variable j will be referred to as the “file j”) on the migration-source medium i to the migration-destination medium i′ (Step S5).

After the copy of the file j is completed, the link management unit 431 in the LTFS 43 updates the symbolic link of the link management information 432 (Step S6). For example, the link management unit 431 changes the “link destination” of the entry specified by the “file name” of the file j in the link management information 432, for example, from the file path of the migration-source medium i to the file path of the migration-destination medium i′.

Subsequently, the migration process unit 433 increments the variable j (Step S7), and determines whether or not j=n holds true (Step S8). When j=n does not hold true (No at Step S8), there is any file that has not been migrated yet in the migration-source medium i. Hence, the process transitions to Step S5 wherein the migration process unit 433 copies files that have not been migrated yet in the migration-source medium i to the migration-destination medium i′.

Otherwise, when j=n holds true (Yes at Step S8), the migration process unit 433 unmounts the migration-source medium i and the migration-destination medium i′ from the drives a and b, respectively (Steps S9 and S10).

Subsequently, the migration process unit 433 increments the variables i and i′ (Step S11), and determines whether or not i=m holds true (Step S12). When i=m does not hold true (No at Step S12), there is any migration-source medium 66 that has not been migrated yet. Hence, the process transitions to Step S2 wherein the migration process unit 433 executes a migration of the subsequent medium 66.

Otherwise, when i=m holds true (Yes at Step S12), the process ends.

### (1-3-2) Access Receiving Process

Next, exemplary operations of an access receiving process in the LTFS server 4 will be described.

Because the access receiving process is executed in response to receiving an access request from the terminal 8 or the management server 3, the access receiving process is executed asynchronous with the migration process. Therefore, in the following descriptions, the operation that cooperates with the migration process may be an interruption process to the migration process.

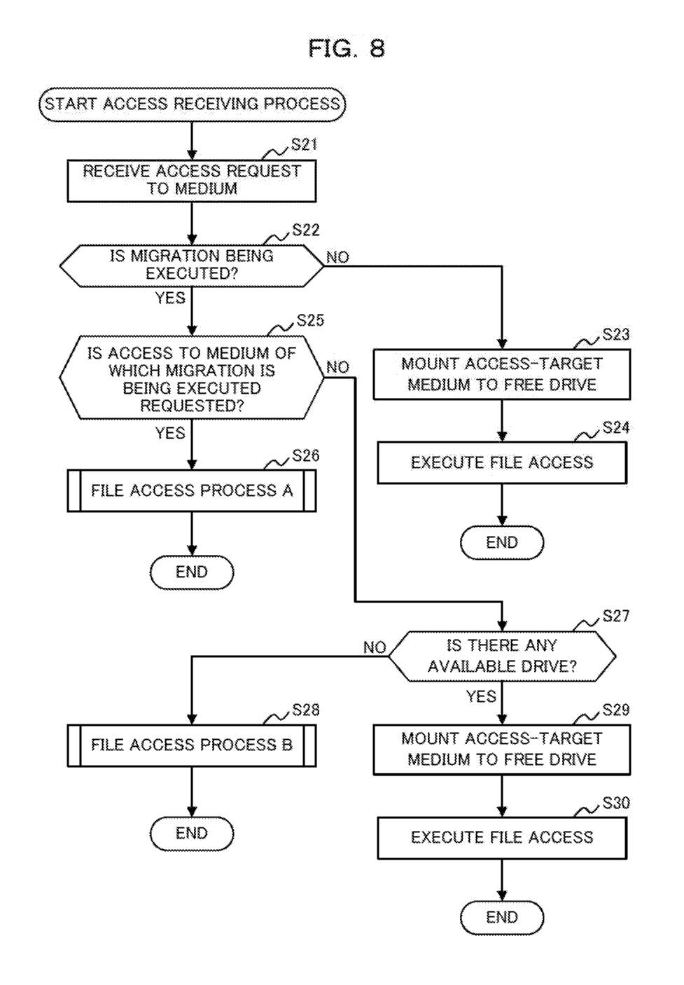

When a user accesses a file via a symbolic link, as exemplified in FIG. 8, the LTFS server 4 receives an access request from the terminal 8 or the management server 3 to a medium 66 through the communication unit 41 (Step S21).

The access control unit 434 in the LTFS 43 determines whether or not a migration is being executed (Step S22).

When no migration execution is being executed (No at Step S22), the access control unit 434 mounts the medium 66 having the access-target file recorded thereon, to a free drive 61 (Step S23), and executes a file access (Step S24). For example, in Step S24, the access control unit 434 opens the file, and executes a read or write (update), replies the terminal 8 or the management server 3 with an access result, such as data that has been read or whether data can be read or written, and the process ends.

When a migration execution is being executed in Step S22 (Yes at Step S22), the access control unit 434 determines whether or not the access is an access to a medium 66 that is undergoing the migration (Step S25). When the access is an access to a medium 66 that is undergoing the migration (Yes at Step S25), the access control unit 434 executes a file access process A that will be described later (Step S26), and the process ends.

Otherwise, when the access is not the access to a medium 66 that is undergoing the migration (No at Step S25), the access control unit 434 determines whether or not there is any available free drive 61 (Step S27). When there is no available free drive 61 (No at Step S27), the access control unit 434 executes a file access process B that will be described later (Step S28), and the process ends.

When there is an available free drive 61 (Yes at Step S27), the access control unit 434 mounts the medium 66 having the access-target file recorded thereon, to a free drive 61 (Step S29), and executes a file access (Step S30). For example, the access control unit 434 replies the terminal 8 or the management server 3 with an access result in Step S30, and the process ends.

Note that the access-destination medium 66 in Steps S24 and S30 may be a medium 66 in which no migration has been executed yet or a migration has been executed. When no migration has been executed yet, a copy has not been executed yet and therefore a file on a previous-generation medium 66 is accessed in Steps S24 and S30. On the other hand, when a migration has been executed, the copy has been executed and symbolic links have been updated and therefore a file on a new-generation medium 66 is accessed in Steps S24 and S30.

Otherwise, when no migration has been executed yet, symbolic links have not been updated yet and therefore a file on the previous-generation medium 66 is accessed in Steps S24 and S30. In this case, when the turn of a migration to that the medium 66 comes after a given time, for example, an updated file on the previous-generation medium 66 is copied to a new generation medium 66. Further, the symbolic link to the updated file is updated from that file on the previous-generation medium 66 to the same file on the new generation medium 66.

### (1-3-3) File Access Process A

Next, the file access process A in Step S26 depicted in FIG. 8 will be described.

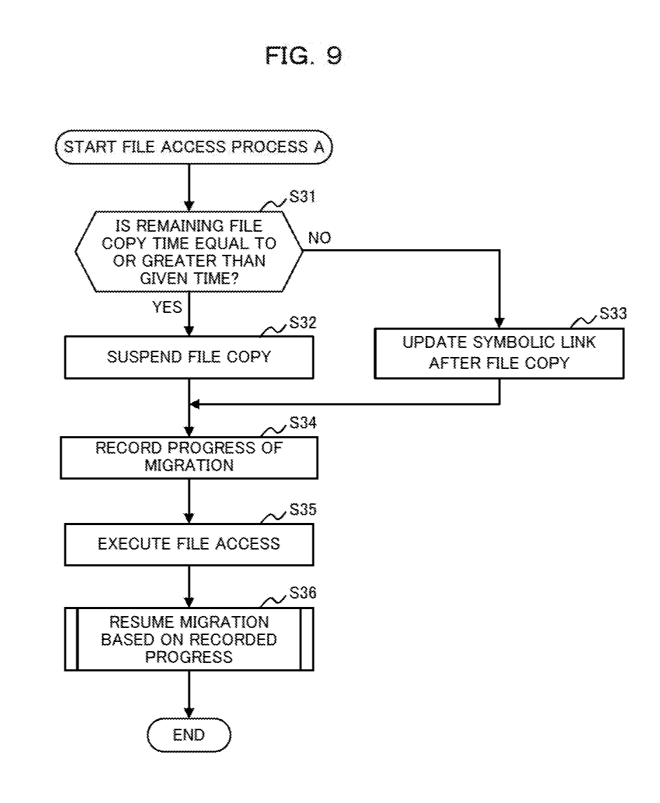

As exemplified in FIG. 9, the access control unit 434 obtains (e.g., calculates) remaining file copy time related to a file being copied in a migration process, and determines whether or not the remaining file copy time is equal to or greater than a given time (Step S31).

When the remaining file copy time is equal to or greater than the given time (Yes at Step S31), the access control unit 434 suspends the file copy (Step S32), and the process proceeds to Step S34. The suspension of the file copy may be instructed to the migration process unit 433 using an interruption to the migration process.

Otherwise, when the remaining file copy time is not equal to or greater than the given time (No at Step S31), after the file copy is completed (Step S33), the access control unit 434 proceeds to the process in Step S34. In Step S33, after the completion of the file copy, the symbolic link is updated by the migration process unit 433 (refer to Steps S5 and S6 in FIG. 7). After the symbolic link is updated, the access control unit 434 may instruct a wait to the migration process unit 433 using an interruption after the completion of the current file copy such that a subsequent file or medium 66 is prevented from being migrated.

In Step S34, the access control unit 434 records the progress of the migration in the link management information 432 via the link management unit 431, for example. For example, the access control unit 434 may set a value of “1” to the “progress flag” in the link management information 432 for the file a migration of which has been suspended. Note that the file for which a value of “1” is set to the “progress flag” may be a file a copy of which has been suspended when the process flows through step S32, and may be a file that is selected as a subsequent copy target when the process flows through Step S33.

Note that in Step S34, in addition to setting of the “progress flag” in the link management information 432, a wide variety of information, such as variables used in a migration process and data of the file, may be recorded in a memory or the like, for example.

Subsequently, the access control unit 434 executes a file access (Step S35). For example, the access control unit 434 replies the terminal 8 or the management server 3 with an access result in Step S34. Because the access-target medium 66 has already been mounted to a drive 61 for a migration in Step S35, the drive 61 is not required to be exchanged.

Note that the access-destination medium 66 in Step S35 may be a medium 66 on which no migration has been executed yet, or maybe a medium 66 a migration of which has already been executed. When no migration has been executed yet, a copy has not been executed yet and therefore a file on a previous-generation medium 66 is accessed in Step S35. Otherwise, when a migration has been executed, the copy has been executed and symbolic links have been updated and therefore a file on a new-generation medium 66 is accessed in Step S35.

Once the file access is completed, the access control unit 434 may instruct the migration process unit 433 to resume the migration process unit 433. In response to the instruction from the access control unit 434, the migration process unit 433 resumes the suspended migration process based on the recorded information, e.g., the “progress flag” (Step S36). This is the end of the file access process A.

### (1-3-4) File Access Process B

Next, the file access process B in Step S28 depicted in FIG. 8 will be described.

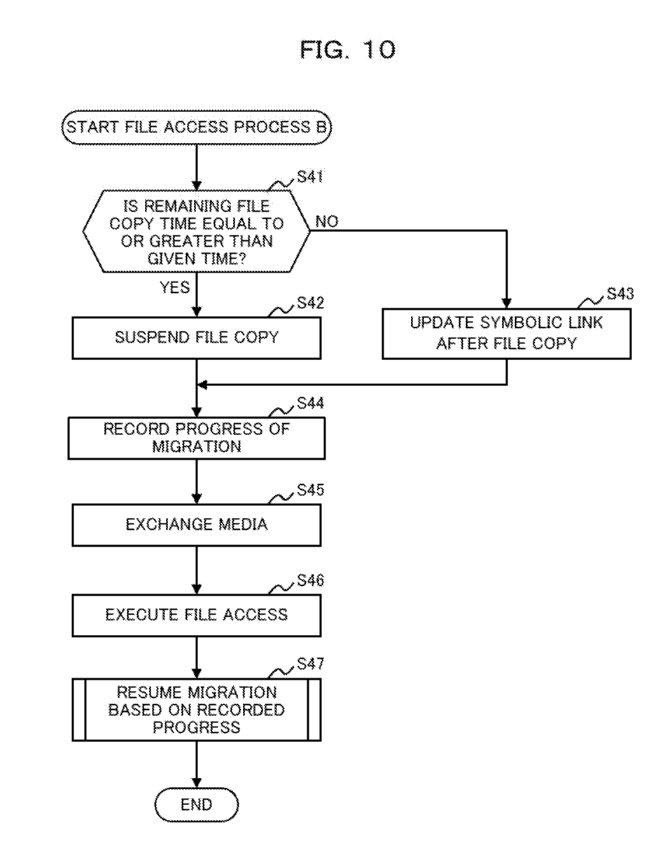

As exemplified in FIG. 10, because processes in Steps S41 to S44 are the same as those in Steps S31 to S34 in the file access process A in FIG. 9, respectively, the descriptions therefor will be omitted.

Once the access control unit 434 records the progress of the migration in Step S44, the access control unit 434 controls an exchange process to mount an access-target medium 66 to the drive 61 that was used in the suspended migration, for example (Step S45). The exchange process may include an instruction for instructing the library 6 to remove a migration-source medium 66 or a migration-destination medium 66 from that drive 61, and an instruction to insert or connect the access-target medium 66 to the drive 61.

This permits accesses to the access-target medium 66 to be made. Because processes in Steps S46 and S47 are the same as those in Steps S35 and S36 in the file access process A in FIG. 9, respectively, the descriptions therefor will be omitted. Upon the migration is resumed in Step S47, the access control unit 434 or the migration process unit 433 may execute an exchange process to mount a migration-source medium 66 or a migration-destination medium 66 to the drive 61 used in the access.

### (1-4) Exemplary Hardware Configuration

Next, an exemplary hardware configuration of the storage system 1 in accordance with one embodiment will be described. Note that the respective controllers 62-64 for the management server 3, the LTFS server 4, and the library 6 may have similar hardware configurations. Therefore, a computer 10 will be described as an exemplary hardware configuration of those controllers 62-64.

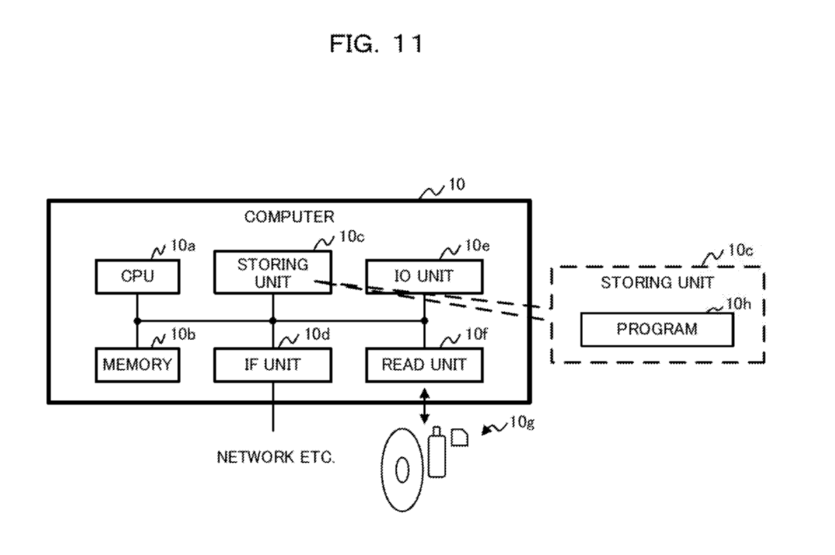

As depicted in FIG. 11, the computer 10 may include a central processing unit (CPU) 10a, a memory 10b, a storing unit 10c, an interface (IF) unit 10d, an input/output (IC)) unit 10e, and a read unit 10f, for example.

The CPU 10a represents one example of a processor that carries out a wide variety of controls and computations. The CPU 10a may be communicatively connected to blocks in the computer 10 through a bus. Note that an electric circuit, such as an integrated circuit (IC), e.g., a micro processing unit (MPU), an application specific integrated circuit (ASIC), a field programmable gate array (FPGA), may be used as a the processor, in place of a computation processing unit (e.g., the CPU 10a). For example, the controllers 62-64 for the library 6 may be embodied by one or more of integrated circuits.

The memory 10b represents one example of hardware that stores information of a wide variety of data, programs, and the like. Examples of the memory 10b include a volatile memory, e.g., a random access memory (RAM), for example. For example, the memory 10b in the LTFS server 4 may store information, e.g., the link management information 432.

The storing unit 10c represents one example of hardware that stores information of a wide variety of data, programs, and the like. Examples of the storing unit 10c include a wide variety of storage devices, such as a magnetic disk device, e.g., a HDD; a semiconductor drive device, e.g., an SSD; a non-volatile memory, e.g., a flush memory and a read only memory (ROM); and the like.

For example, the storing unit 10c may store a control program 10h that embodies all or apart of functions of the computer 10. The control program 10h may include programs that embody functions of the respective controllers 62-64 for the management server 3, the LTFS server 4, and the library 6 in accordance with one embodiment.

The CPU 10a can embody the functions of the computer 10 by expanding the control program 10h stored in the storing unit 10c to the memory 10b and executing it, for example. When at least a part of the functions of the computer 10 (e.g., the management server 3 and the LTFS server 4) is embodied by a cloud environment or the like, the control program 10h may be provided to both the computer 10 and cloud environment, or the control program 10h may be suitably divided and may be provided to the computer 10 and the cloud environment.

The IF unit 10d represents one example of a communication interface that controls connections, communications, and the like, through networks among the respective controllers 62-64 for the network 7, the management server 3, the LTFS server 4, and the library 6. Examples of the IF unit 10d include an adaptor compliant with a LAN or the SCSI, for example.

Note that the control program 10h may be downloaded from a network or the like to the computer 10 via the IF unit 10d.

The IO unit 10e may include at least a part of an input unit (e.g., a mouse, a keyboard, and operation buttons), and output units (e.g., a display and a printer). For example, the input unit may be used for a wide variety of operations, such as entering a various types of information of migration processes in the management server 3, and setting of the “given time” in the LTFS server 4. The output unit may be used to display a wide variety of information entered, process results, and the like.

The read unit 10f represents one example of a reader that reads information of data and programs recorded in the storage medium 10g. The read unit 10f may include a terminal or device, to which a computer-readable storage medium 10g can be connected or inserted. Examples of the read unit 10f include an adaptor compliant with the Universal Serial Bus (USB) or other standards, a drive device that accesses recording disks, a card reader that accesses a flush memory (e.g., an SD card), for example . Note that the control program 10h may be stored in the storage medium 10g.

Examples of the storage medium 10g include non-transitory storage media, such as flexible disks, optical disks (e.g., as CDs, DVDs, Blu-ray discs, and HVDs), and flush memories (e.g., a USB memory and an SD card). Note that examples of CDs include CD-ROMs, CD-Rs, CD-RWs and the like, for example. Examples of DVDs include DVD-ROMs, DVD-RAMS, DVD-Rs, DVD-RWs, DVD+Rs, DVD+RWs, and the like, for example.

The above-described hardware configuration of the computer 10 is exemplary. Accordingly, hardware may be added or removed (e.g., addition or removal of any blocks), may be divided, or may be combined in any combination, or a bus may be added or removed in the computer 10, where appropriate. Further, the hardware configurations of the management server 3 and the LTFS server 4 may be integrated into a single computer 10, or the hardware configurations of the controllers 62-64 for the library 6 may be integrated into a single computer 10.

### (2) Miscellaneous

As will be described below, the above-described technique in accordance with one embodiment may be practiced in modifications and variations.

For example, in the LTFS server 4, the functions of the communication unit 41, the conversion unit 42, and the LTFS 43 may be combined in any combination, or may be divided. Further, in the LTFS 43, the functions of the link management unit 431, the migration process unit 433, and the access control unit 434 may be combined in any combination, or may be divided. Further, at least a part of the above-described functions in the LTFS server 4 may be included in an apparatus different from the LTFS server 4.

While a migration is carried out as one example of data transfers between media 66 in one embodiment, this is not limiting, and data transfer may be any of a wide variety of copy or transfer processes other than migrations.

Furthermore, the library 6 has been described as a tape library employing magnetic tape cartridges in one embodiment, this is not limiting. For example, a technique in accordance with one embodiment can be applied to the library 6 that is an optical disk library employing optical disks (e.g., CDs, DVDs, Blu-ray discs, and HVDs), or optical disk cartridges.

Further, when the library 6 can contain both magnetic tape cartridges and optical disks or optical disk cartridges, data transfers from a tape to an optical disk or an optical disk cartridge, or data transfers in the opposite directions may be carried out.

Furthermore, a technique in accordance with one embodiment is not limited to data transfers in a single library 6, and may be applied to data transfers between libraries 6. In this case, data transfer source and data transfer destination libraries 6 may be similar types of tape libraries or optical disk libraries, or may be in different types.

In one aspect, the availability of a storage apparatus can be improved.

All examples and conditional language recited provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage apparatus comprising:
a library apparatus comprising a plurality of removable media contained therein; and
a control apparatus configured to control accesses to the plurality of removable media on a file-by-file basis,
wherein the control apparatus comprises:
a memory; and
a processor connected to the memory, and
the processor is configured to:
cause the library apparatus to execute a migration process of data between removable media on a file-by-file basis;
in response to an access request being received while the migration process is being executed, determine whether or not the access request targets an executing removable medium in which the migration process is being executed;
when the access request targets the executing removable medium, control to suspend the migration process; and
after the migration process is suspended, access an access-target file recorded in the removable medium targeted by the access request.

2. The storage apparatus according to claim 1, wherein
the access-target file is designated by a soft link in the access request, and
the processor is configured to:
manage file paths of removable media having files recorded therein and soft links in association with each other; and
for each file, a copy of which is completed in the migration process, update a file path associated with a soft link, with a file path of a migration-destination removable medium.

3. The storage apparatus according to claim 1, wherein the processor is configured to control to suspend the migration process based on information about remaining copy time of a file being copied in the migration process.

4. The storage apparatus according to claim 3, wherein the processor is configured to:
when the remaining copy time is equal to or greater than a given time, control to stop an ongoing copy of the file to suspend the migration process; and
when the remaining copy time is less than the given time, control to suspend the migration process after the ongoing copy of the file is completed.

5. The storage apparatus according to claim 1, wherein the processor is configured to control to resume the suspended migration process after the access is executed.

6. The storage apparatus according to claim 1, wherein the processor is configured to, when the access request does not target the executing removable medium and when there is no available medium processing apparatus used for a removable medium targeted by the access request in the library apparatus, control to suspend the migration process.

7. The storage apparatus according to claim 6, wherein the processor is configured to, after the migration process is suspended, for a medium processing apparatus used for the executing removable medium, control to exchange the executing removable medium and a removable medium targeted by the access request.

8. A control apparatus comprising:
a memory; and
a processor connected to the memory,
the processor is configured to:
cause the library apparatus, comprising a plurality of removable media contained therein, to execute a migration process of data between removable media on a file-by-file basis;
in response to an access request being received while the migration process is being executed, determine whether or not the access request targets an executing removable medium in which the migration process is being executed;
when the access request targets the executing removable medium, control to suspend the migration process; and
after the migration process is suspended, access an access-target file recorded in the removable medium targeted by the access request.

9. The control apparatus according to claim 8, wherein
the access-target file is designated by a soft link in the access request, and
the processor is configured to:
manage file paths of removable media having files recorded therein and soft links in association with each other; and
for each file, a copy of which is completed in the migration process, update a file path associated with a soft link, with a file path of a migration-destination removable medium.

10. The control apparatus according to claim 8, wherein the processor is configured to control to suspend the migration process based on information about remaining copy time of a file being copied in the migration process.

11. The control apparatus according to claim 10, wherein the processor is configured to:
when the remaining copy time is equal to or greater than a given time, control to stop an ongoing copy of the file to suspend the migration process; and
when the remaining copy time is less than the given time, control to suspend the migration process after the ongoing copy of the file is completed.

12. The control apparatus according to claim 8, wherein the processor is configured to control to resume the suspended migration process after the access is executed.

13. The control apparatus according to claim 8, wherein the processor is configured to, when the access request does not target the executing removable medium and when there is no available medium processing apparatus used for a removable medium targeted by the access request in the library apparatus, control to suspend the migration process.

14. The control apparatus according to claim 13, wherein the processor is configured to, after the migration process is suspended, for a medium processing apparatus used for the executing removable medium, control to exchange the executing removable medium and a removable medium targeted by the access request.

15. A non-transitory computer-readable storage medium having stored therein a control program for causing a computer to execute a process comprising:
causing the library apparatus, comprising a plurality of removable media contained therein, to execute a migration process of data between removable media on a file-by-file basis;
in response to an access request being received while the migration process is being executed, determining whether or not the access request targets an executing removable medium in which the migration process is being executed;
when the access request targets the executing removable medium, controlling to suspend the migration process; and
after the migration process is suspended, accessing an access-target file recorded in the removable medium targeted by the access request.

16. The non-transitory computer-readable storage medium according to claim 15, wherein
the access-target file is designated by a soft link in the access request,
the process further comprises:
managing file paths of removable media having files recorded therein and soft links in association with each other; and
for each file, a copy of which is completed in the migration process, updating a file path associated with a soft link, with a file path of a migration-destination removable medium.

17. The non-transitory computer-readable storage medium according to claim 15, wherein the process further comprises controlling to suspend the migration process based on information about remaining copy time of a file being copied in the migration process.

18. The non-transitory computer-readable storage medium according to claim 17, wherein the process further comprises:
when the remaining copy time is equal to or greater than a given time, controlling to stop the ongoing copy of the file to suspend the migration process; and
when the remaining copy time is less than the given time, controlling to suspend the migration process after the ongoing copy of the file is completed.

19. The non-transitory computer-readable storage medium according to claim 15, wherein the process further comprises controlling to resume the suspended migration process after the access is executed.

20. The non-transitory computer-readable storage medium according to claim 15, wherein the process further comprises, when the access request does not target the executing removable medium and when there is no available medium processing apparatus used for a removable medium targeted by the access request in the library apparatus, controlling to suspend the migration process.
